(19) United States
(12) Patent Application Publication
(10) Pub. No.: US 2018/0304425 A1
(43) Pub. Date: Oct. 25, 2018

(54) MACHINING CENTER FOR MACHINING AN ELONGATE WORKPIECE

(71) Applicant: SIEMENS AKTIENGESELLSCHAFT, MÜNCHEN (DE)

(72) Inventor: SUSANNE KAMENZKY, BERLIN (DE)

(21) Appl. No.: 15/769,363

(22) PCT Filed: Sep. 29, 2016
(86) PCT No.: PCT/EP2016/073180

§ 371 Date: Apr. 19, 2018

(30) Foreign Application Priority Data
Oct. 26, 2015 (DE) 10 2015 220 882.6

(51) Int. Cl. B23Q 1/52; B23C 3/00; B23Q 1/48; B23Q 1/76

(52) U.S. Cl. CPC B23Q 1/527; B23C 3/002; B23Q 2230/008; B23Q 1/763; B23Q 1/4857

(57) ABSTRACT

Provided is a machining center, in particular a 5-axis milling machine, for machining an elongate workpiece, in particular a turbine blade, including an elongate machine bed extending in a longitudinal direction, a machining device movably retained on the machine bed, two clamping devices, which are retained on the machine bed in such a way that the clamping devices lie opposite each other in the longitudinal direction and which are designed to clamp the free ends of the workpiece and to rotate the clamped workpiece about a workpiece axis of rotation, wherein at least one clamping device can be moved in the longitudinal direction of the machine bed and at least one clamping device has a drive device designed to rotate the clamped workpiece, in particular a stepper motor, and a steady rest, which is retained on the machine bed and positioned between the clamping devices.

### CROSS-REFERENCE TO RELATED APPLICATIONS

This application claims priority to PCT Application No. PCT/EP2016/073180, having a filing date of Sep. 29, 2016, based on German Application No. 10 2015 220 882.6, having a filing date of Oct. 26, 2015, the entire contents both of which are hereby incorporated by reference.

### FIELD OF TECHNOLOGY

The following relates to a machining center, especially a 5-axis milling machine, for machining an elongate workpiece, especially a turbine blade, with a elongate machine bed which extends in a longitudinal direction, a machining device which is movably mounted on the machine bed, two clamping devices which are mounted on the machine bed opposite each other in the longitudinal direction and designed for clamping the free ends of the workpiece and for rotating the clamped workpiece around a workpiece rotational axis, wherein at least one clamping device can be moved in the longitudinal direction of the machine bed and at least one clamping device has a drive device which is designed for rotating the clamped workpiece, especially a stepper motor, and a steady rest which is mounted on the machine bed, positioned between the clamping devices, and can be moved in the longitudinal direction. The following also relates to a method for machining an elongate workpiece, especially a turbine blade, in such a machining center.

### BACKGROUND

During the production of a turbine blade, a blank is normally cast in a first step. This is then machined in a machining center, removing material for example by grinding, milling or the like, to remove flash which is created during the casting and/or to form the precise final geometry of the blade root or the blade airfoil. Alternatively, it is also possible, however, to machine turbine blades directly from the solid material without prior casting of a blank.

For the machining of turbine blades, machining centers of the type referred to in the introduction, inter alia, are used. They normally comprise an elongate machine bed which extends in a longitudinal direction and two clamping devices which are mounted on the machine bed opposite each other in the longitudinal direction and are designed both for clamping the free ends of the workpiece and for rotating the clamped workpiece around a workpiece rotational axis. To this end, at least one of the clamping devices can be moved in the longitudinal direction of the machine bed to be able to arrange a workpiece to be machined between the clamping devices, and at least one of the clamping devices has a drive device which is designed for rotating the clamped workpiece, for example in the form of a stepper motor. Provision is made on the machine bed for a machining device which is movably mounted relative to the clamped workpiece and designed for accommodating and for driving a machining unit. A steady rest, which can be moved in the longitudinal direction, can be positioned between the clamping devices. This steady rest serves for supporting the workpiece to be machined in a center region between the two clamping devices to counteract sagging of the long workpiece.

A disadvantage of such machining centers exists in the fact that the free ends of the workpiece, by which this is clamped, cannot be machined. Accordingly, the workpiece should be removed from the machining center, whereupon the machining of the free ends is carried out in a separate machine. The re-clamping and realignment of the workpiece is, however, associated with a large expenditure of time and can be accompanied by manufacturing inaccuracies, which is not desirable.

### SUMMARY

An aspect relates to an alternative machining center and an alternative method of the type referred to in the introduction.

For achieving this aspect, embodiments of the present invention create a machining center of the type referred to in the introduction which is characterized in that a second steady rest is positioned between the clamping devices and can be moved in the longitudinal direction, and in that both clamping devices have in each case a drive device which is designed for rotating the clamped workpiece, especially a stepper motor. For machining a free end of a workpiece which is held between the clamping devices and supported in the middle by the first steady rest, such a second steady rest can be arranged in such a way that it supports the workpiece directly adjacent to the free end to be machined. Consequently, the engagement between the clamping device holding the free end to be machined and the workpiece can be released and the clamping device can be moved in such a way that the free end is accessible for the machining which is to follow. Since both clamping devices can be moved in the longitudinal direction and a separate drive device is made available, the machining of both free ends of the workpiece is possible.

The two clamping devices and the two steady rests are advantageously arranged on a common linear guide and can be moved along this. A common linear guide ensures that the relative alignment of the clamping devices and the steady rests is maintained if the clamping devices or the steady rests are moved in the longitudinal direction. Moreover, a common linear guide can be inexpensively provided on the machine bed of the machining center and facilitates the controlling of the clamping devices and the steady rests.

According to a development of embodiments of the present invention, the machining device is arranged on a separate linear guide, which extends in the longitudinal axis, and can be moved along this. In this way, it can be ensured that each region of the clamped workpiece can be machined.

The clamping devices, the steady rests and the machining device are advantageously arranged in each case on a separate machine platen which is mounted on an associated linear guide and can be moved along this.

The clamping devices, the steady rests and the machining device are preferably connected in each case to the associated machine platen via at least one further linear guide which extends perpendicularly to the longitudinal direction of the machine bed. A further linear guide creates an additional degree of freedom within which the machining unit and the workpiece can be moved and positioned relative to each other.

According to one embodiment of the present invention, each steady rest has an annular basic body which on its inner side has an annular element which is provided with clamping elements and is designed to be rotated around the workpiece rotational axis. The annular element, which is designed to be rotated around the workpiece rotational axis, allows the workpiece which is held by the clamping elements inside the annular basic body to be rotated around the workpiece rotational axis.

According to one development, each steady rest has a separate drive device which is designed for rotating the clamped workpiece around the workpiece rotational axis. The separate drive devices of the steady rests can prevent twisting of the workpiece around the workpiece rotational axis during the machining if they are driven synchronously with the drive devices of the clamping devices. Moreover, a clamped workpiece can also be rotated solely by the drive devices of the steady rests, which can be advantageous in specific cases.

For achieving the object referred to in the introduction, embodiments of the present invention also create a method for machining an elongate workpiece, especially a turbine blade, in a machining center according to embodiments of the invention, comprising the steps:
clamping the free ends of the workpiece using the two clamping devices, wherein the workpiece is held in a center region between the two clamping devices using at least one of the two steady rests; and
machining the workpiece in a region between its free ends, wherein for machining a free end of the workpiece the following steps are carried out:
clamping the workpiece directly in front of the free end to be machined using one steady rest, whereas the other steady rest holds the workpiece in a center region between the two clamping devices;
releasing the clamping device which holds the free end of the workpiece to be machined and moving the clamping device away from the free end to be machined; and
machining the free end of the workpiece.

### BRIEF DESCRIPTION

Some of the embodiments will be described in detail, with references to the following figures, wherein like designations denote like members, wherein:

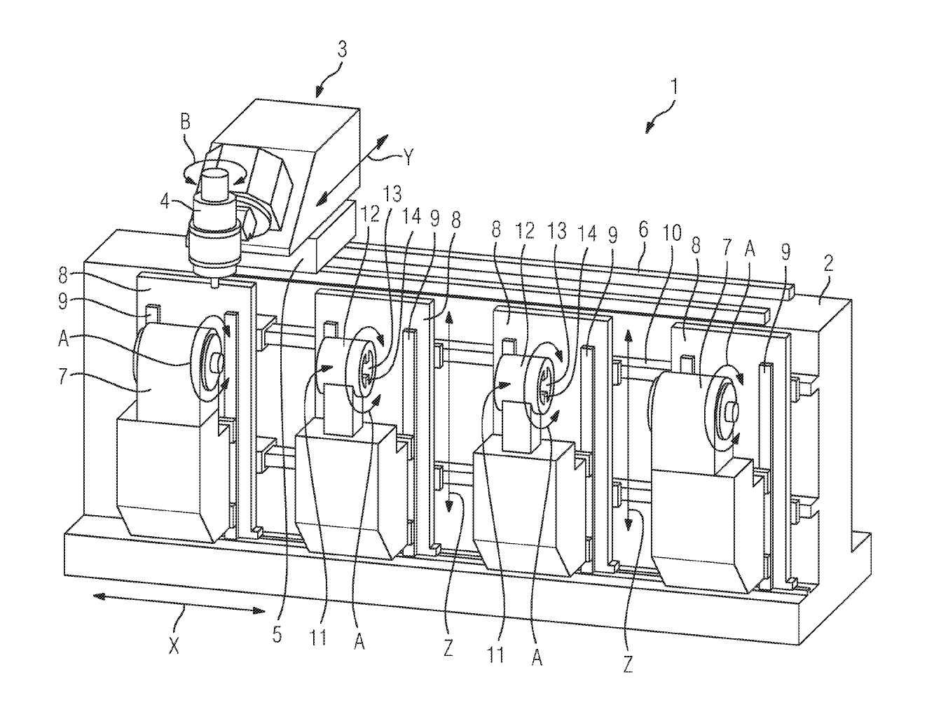

FIG. 1 shows a perspective side view of a machining center according to an embodiment of the present invention.

### DETAILED DESCRIPTION

FIG. 1 shows a machining center 1, designed as a 5-axis milling machine, which serves for the machining of an elongate workpiece, especially a turbine blade. The machining center 1 comprises an elongate machine bed 2 which extends in an X-direction, wherein the X-direction corresponds to the longitudinal direction in the present case. Movably mounted on the machine bed 2 is a machining device 3 which in the present case accommodates a milling unit 4 in a rotatable manner around a machining rotational axis B and is advantageously designed for accommodating alternative machining units, such as for accommodating a grinding, drilling and/or eroding unit, just to name some examples. To be more specific, the machining device 3 is arranged on a machine platen 5 and can be moved relative to this along a linear guide, not shown in more detail, in a Y-direction which extends perpendicularly to the X-direction. The machine platen 5 in turn is arranged on the machine bed 2 and can be moved relative to this along a linear guide 6 which extends in the X-direction.

The machining center 1 also comprises two clamping devices 7 which are mounted on the machine bed 2 opposite each other in the X-direction and are designed for clamping the free ends of the workpiece and for rotating the clamped workpiece around a workpiece rotational axis A which extends in the X-direction. For this purpose, both clamping devices 7 have in each case corresponding clamping means or a clamp and a drive device which is designed for rotating the clamped workpiece, for example in the form of a stepper motor. The two clamping devices 7 are arranged in each case on a machine platen 8 and can be moved relative to this along a linear guide 9 which extends in a Z-direction, wherein the Z-direction extends both perpendicularly to the X-direction and perpendicularly to the Y-direction. The machine platens in turn are movably mounted along a common linear guide 10 which extends in the X-direction and is fastened on the machine bed 2.

Furthermore, the machining center 1 comprises two steady rests 11 which are mounted on the machine bed 2 and positioned between the clamping devices 7. The steady rests 11 are arranged in each case on a machine platen 8 and can be moved relative to this along a linear guide 9 which extends in the Z-direction. The machine platens 8 in their turn are movably mounted on the linear guide which extends in the X-direction and on which the clamping devices 7 are also positioned. Each steady rest 11 has an annular basic body 12 which on its inner side is provided with an annular element 13 which is designed to be rotated around the workpiece rotational axis A. The annular element 13 is equipped with clamping elements 14 which hold and fix between them a workpiece which is clamped between the clamping devices 7. Each steady rest 11 also comprises a separate drive device (not shown) which is designed for rotating the clamped workpiece around the workpiece rotational axis A. Alternatively, however, the steady rests 11 can also be designed without separate drive devices.

For machining an elongate workpiece, especially a turbine blade, the free ends of the workpiece are clamped using the two clamping devices 7, wherein the workpiece is held in a center region between the two clamping devices 7 using at least one of the two steady rests 11. The workpiece is them machined in a region between its free ends.

For machining a free end of the workpiece, the workpiece is clamped directly in front of the free end to be machined using the adjacently arranged steady rest 11, whereas the other steady rest 11 additionally supports the workpiece in a center region between the clamping devices 7. The clamping means or clamp of the clamping device 7 which holds the free end to be machined are then released, whereupon the clamping device 7 is moved away in the X-direction from the free end of the workpiece to be machined in such a way that the free end is accessible for machining by means of the machining unit 4. After this, the free end of the workpiece is machined by the machining unit 4. During this machining, the workpiece can be rotated around the workpiece rotational axis A by one or more of the drive devices of the remaining clamping device 7 or of the steady rests 11 according to choice. The other free end of the workpiece can also be machined in a similar manner.

An essential advantage of the previously described method exists in the fact that the entire workpiece can be machined using the machining center 1. During the machining, at least three regions of the workpiece can always be fixed in the process, which enables a very accurate machining of the workpiece.

Although the invention has been fully illustrated and described in detail by the preferred exemplary embodiment, the invention is not limited by the disclosed examples and other variations can be derived therefrom by the person skilled in the art without departing from the extent of protection of the invention.

For the sake of clarity, it is to be understood that the use of “a” or “an” throughout this application does not exclude a plurality, and “comprising” does not exclude other steps or elements.

1. A machining center comprising:
a 5-axis milling machine
for machining an elongate workpiece,
wherein said elongate workpiece in a turbine blade,
with an elongate machine bed, which extends in a longitudinal direction, a machining device which is movably mounted on the machine bed, two clamping devices which are mounted on the machine bed opposite each other in the longitudinal direction and are designed for clamping the free ends of the workpiece and for rotating the clamped workpiece around a workpiece rotational axis,
wherein at least one clamping device can be moved in the longitudinal direction of the machine bed and at least one clamping device has a drive device which is designed for rotating the clamped workpiece,
and with a steady rest which is mounted on the machine bed, positioned between the clamping devices and can be moved in the longitudinal direction,
wherein
a second steady rest is mounted on the machine bed, positioned between the clamping devices and can be moved in the longitudinal direction, and in that both clamping devices in each case can be moved in the longitudinal direction and have a drive device which is designed for rotating the clamped workpiece.

2. The machining center as claimed in claim 1, wherein
the two clamping devices and the two steady rests are arranged on a common linear guide and can be moved along this.

3. The machining center as claimed in claim 1, wherein
the machining device is arranged on a separate linear guide which extends in the longitudinal direction and can be moved along this.

4. The machining center as claimed in claim 2. wherein
the clamping devices, the steady rests and the machining device are arranged in each case on a separate machine platen which is mounted on an associated linear guide and can be moved along this.

5. The machining center as claimed in claim 4, wherein
the clamping devices, the steady rests and the machining device are connected in each case to the associated machine platen via at least one further linear guide which extends perpendicularly to the longitudinal direction of the machine bed.

6. The machining center as claimed in claim 1, wherein
each steady rest has an annular basic body which on its inner side has an annular element which is provided with clamping elements and is designed to be rotated around the workpiece rotational axis.

7. The machining center as claimed in claim 6, wherein
each steady rest has a separate drive device which is designed for rotating the clamped workpiece around the workpiece rotational axis.

8. A method for machining an elongate workpiece,
wherein the elongated workpiece is a turbine blade,
in a machining center comprising the steps:
clamping the free ends of the workpiece using the two clamping devices, wherein the workpiece is held in a center region between the two clamping devices using at least one of the two steady rests; and
machining the workpiece in a region between its free ends, wherein
for machining a free end of the workpiece the following steps are carried out:
clamping the workpiece directly in front of the free end to be machined using one steady rest, whereas the other steady rest holds the workpiece in a center region between the two clamping devices;
releasing the clamping device which holds the free end of the workpiece to be machined, and moving the clamping device away from the free end to be machined; and
machining the free end of the workpiece.

9. The machining center of claim 1, wherein the drive device in each case is a stepper motor.
